(19) United States
(12) Patent Application Publication
(10) Pub. No.: US 2016/0252142 A1
(43) Pub. Date: Sep. 1, 2016

(54) ENERGIZING ELEMENTS FOR A CLUTCH

(71) Applicant: Magna Powertrain, Inc., Concord (CA)

(72) Inventor: Darrell F. Greene, Bradford (CA)

(73) Assignee: Magna Powertrain, Inc., Concord (CA)

(21) Appl. No.: 15/149,929

(22) Filed: May 9, 2016

Related U.S. Application Data
(63) Continuation of application No. 14/232,941, filed on Apr. 21, 2014.
(60) Provisional application No. 61/512,160, filed on Jul. 27, 2011.

(51) Int. Cl. F16D 15/00; F16D 13/70

(52) U.S. Cl. CPC F16D 15/00; F16D 13/70

(57) ABSTRACT

An electromagnetic clutch includes a rotatable input member and a rotatable output member. A clutch plate is fixed tar rotation with one of the input member and the output member. An armature plate is axially moveable relative to the other of the input member and the output member. A self-energizing actuator includes energizing elements for converting rotary motion of the input member to linear movement of the armature plate. The actuator includes a biasing member urging relative rotation between the one of the input member and the output member and the armature plate to initially engage the armature plate and the clutch plate. The self-energizing actuator provides an additional clutch engagement force once the input member is driven and also includes an electromagnet to axially translate the armature plate and disengage the armature plate and the clutch plate. Alternative designs for the energizing elements includes a mechanical memory material having any one of a beam shape, a rod shape, a shaped roller or a matrix member.

### CROSS REFERENCE TO RELATED APPLICATIONS

This application claims the benefit of, and incorporates herein by reference for all purposes, U.S. Provisional Patent Application No. 61/512,214 entitled Switchable Water Pump with Dual Friction Plate Actuation; U.S. Provisional Patent Application No. 61/512,220 entitled Clutch Device with Integrated Electric Motor; and U.S. Provisional Patent Application No. 61/512,160 entitled Energizing Elements for a Clutch, each having common inventor Darrell Greene and all filed on Jul. 27, 2011.

### FIELD

This present disclosure relates generally to an improved designs for use as energizing elements in a clutch device. More particularly, the present disclosure relates to improved designs for use as energizing elements in a clutch device that minimize any relative movement between the energizing elements, a clutch plate and a output member of the clutch for transferring a force to the output member.

### BACKGROUND

Clutch devices that utilize ball ramps and balls, particularly in an electromagnetically operated clutch have been utilized commercially in a variety of applications, including in engines for use in vehicles, including in automobiles. One such electromagnetic clutch that utilizes a ball ramp energizing device in the clutch mechanism is disclosed in international publication WO2010/148507 (A1), published Dec. 29, 2010, from international application number PCT/CA/2010/000978, filed Jun. 21, 2010, naming inventor Darrell F. Greene and commonly assigned with this application, then entire contents of which are incorporated herein by reference for all purposes.

In the generally known clutch devices, ball ramps and balls (generally and interchangeably known as “energizing elements”) are utilized to translate a movement of the energizing element caused by a rotational motion into a vertical displacement that can cause the activation and/or deactivation of the clutch mechanism. It is believed that one issue related to the use of such generally known ball ramps and the designs of such energizing elements is that the movement of one or more of the energizing elements may become impeded (e.g., limited) due to a number of factors and thus may reduce the functionality of the overall clutch mechanism and thereby the device and/or system with which it is associated. If the energizing elements become significantly impeded, the entire system could cease functioning. As some illustrative examples, movement may be impeded due to factors such as: small particle contaminants becoming lodged in the ball channel and preventing the ball from moving as freely as desired. Or, over time the channel or the ball becoming worn or damaged preventing the ball from moving as freely as desired. While not exhaustive, the above potential issues need to be addressed.

Accordingly, there remains a very significant need to improve the designs of the energizing elements used in a such energizing element (or ball ramp) clutch devices—particularly, designs which better manage small particle contamination issues and better avoid potential jamming.

### SUMMARY

The present disclosure is directed to an improved roller-style energizing element(s) for use in an energizing mechanism in a clutch device for addressing at least one or more of the issues discussed above. The energizing elements function to translate the rotational motion of an input plate to a vertical motion of an opposing plate for engaging and disengaging the clutch mechanism.

In one exemplary embodiment, the improved energizing elements may comprise a rotational gear that allows a track to move and causes the vertical movement, the track disposed on a sloping surface of the ball ramps.

In another exemplary embodiment, the improved energizing elements may comprise a shaped roller that is at least partially nested on one or more bearing surfaces that are disposed on the input and opposing plates.

In yet another exemplary embodiment, the improved energizing elements may comprise an element that has a mechanical memory that when subjected to a rotational force flexes to create a vertical motion.

### BRIEF DESCRIPTION OF THE DRAWINGS

FIG. 1 represents a ball track and ball configuration of a generally known device;

FIG. 2 represents is a first exemplary embodiment of an energizing element according to the present disclosure;

FIG. 3 represents is an alternative view of the first exemplary embodiment of an energizing element according to the present disclosure;

FIG. 4 represents is a further alternative view of the first exemplary embodiment of an energizing element according to the present disclosure;

FIG. 5 represents is a further alternative view of the first exemplary embodiment of an energizing element according to the present disclosure;

FIG. 6 represents is a second exemplary embodiment of an energizing element according to the present disclosure;

FIGS. 7A and 7B represents is a third exemplary embodiment of an energizing element according to the present disclosure;

FIGS. 8A and 8B represents is a fourth exemplary embodiment of an energizing element according to the present disclosure; and

FIGS. 9A and 9B represents is a fifth exemplary embodiment of an energizing element according to the present disclosure.

### DETAILED DESCRIPTION

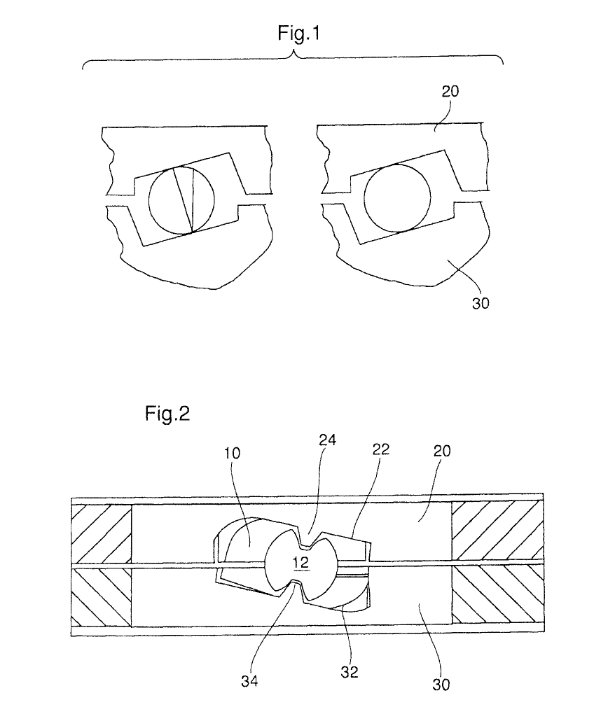

Referring to all of the Figures in general, there is disclosed an plurality of energizing elements 10 that are generally understood to function to translate the rotational motion of an input plate 20 to the rotational and vertical motion (e.g. motion generally transverse to the surface of the plates such as along a direction aligned with the axis of rotation of the plates) of an opposing plate 30 or vice versa. FIG. 1 discloses one such generally know type of ball ramp clutch which can be understood from the disclosure of United States Patent Application Publication Number US 2012/0097496, published on Apr. 26, 2012, in the name of Greene and commonly assigned with this application, the entire contents of which are incorporated herein by reference for all purposes. Another generally known ball ramp clutch example is described in PCT Publication WO/2010/148507 A1, which is also incorporated by reference for all purposes. It is also generally understood that a force may be used to disengage the rotational motion of the input plate from the output member.

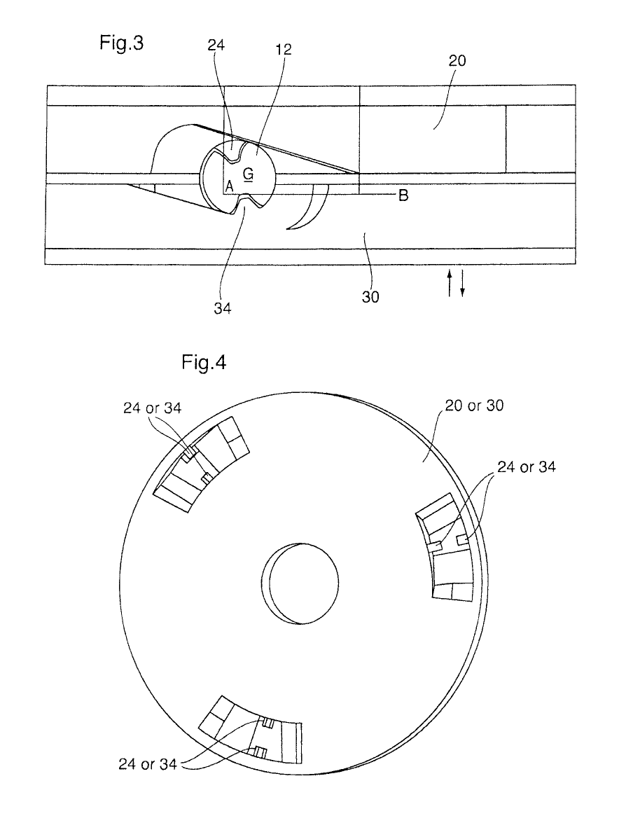

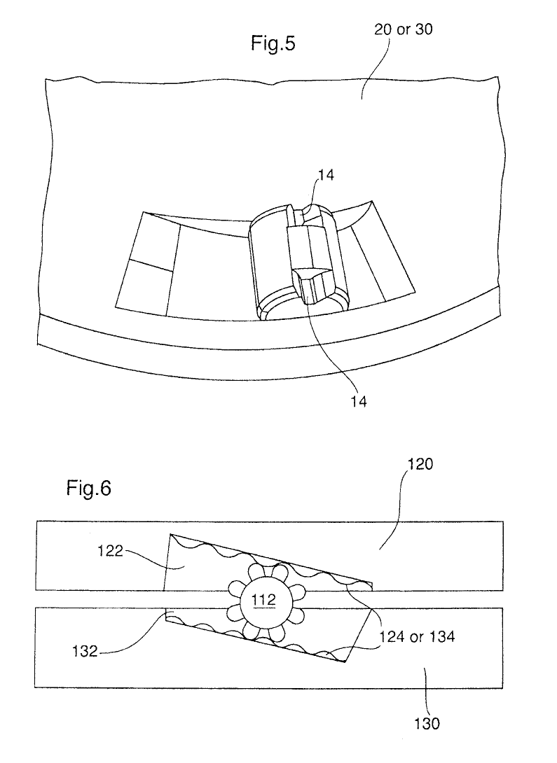

In a first exemplary embodiment as shown in FIGS. 2-5, a new design for an improved roller-style energizing element 10 for use in the clutch mechanism or device (not shown) is disclosed. The energizing element 10 is a roller member 12. The improved energizing elements 10 may be disposed in slots 22, 32, the slots disposed on the input plate 20 and the opposing plate 30, respectively. The slots are adapted to contain the roller member when assembled. The slots 22, 32 can also include bearing surfaces 24, 34 as shown. The bearing surfaces 24, 34 are adapted to reasonably mutually mate with roller bearing surfaces 14 and allow for the roller member 12 to rotate. The rotation of the roller member 12 is translated into vertical motion (as designated by the arrows as best shown in FIG. 3).

In a second exemplary embodiment, as shown in FIG. 6, a new design for improved roller-style energizing element 100 for a clutch device (not shown) is disclosed. An energizing element 100 may be comprised of at least one (or more) roller member 112. The clutch mechanism includes slots 122, 132 disposed on the input plate 120 and the opposing plate 130, respectively. The slots 122, 132 are adapted to contain the roller member 112 when assembled. The slots 122, 132 also include a series of undulating bearing surfaces, scallop shapes or gear teeth 124, 134. These bearing surfaces 124, 134 are adapted to match or mate with an undulating roller bearing surface 114 and allow for the roller member 112 to move along the sloped slots 122, 132 and thus translate the rotational motion into vertical motion between the plates 120, 130. It is contemplated that the roller member 112 may be rotationally fixed to one of the plates 120, 130.

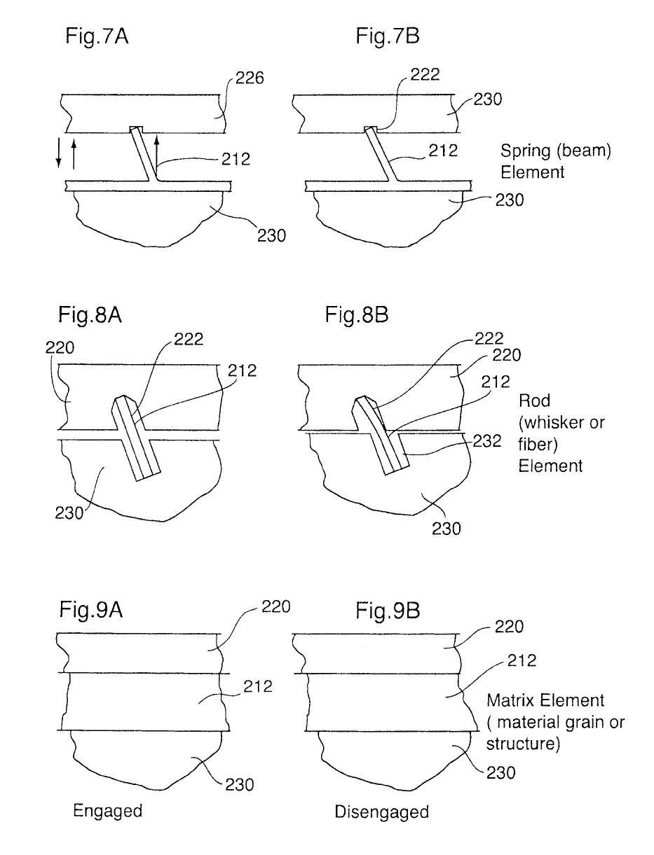

In third, fourth and fifth exemplary embodiments, as shown in FIGS. 7A and 78, FIGS. 8A and 8B, and FIGS. 9A and 9B, respectively, a new design for an improved energizing element 200 for use in a clutch device (not shown) is disclosed. The energizing element 200 may be comprised of one or more elements 212 that have a mechanical memory. The mechanical memory includes the ability of the element 212 to return to its original geometric position when the force (e.g. rotational movement of the input plate) is removed. Examples of this embodiment, best shown in FIGS. 7-9, wherein each of the designs for the elements 212 are shown in engaged (FIG. A) and disengaged positions (FIG. B).

In the fourth exemplary embodiment, shown in FIGS. 7A and 7B, the energizing element 212 comprises a spring or beam-shaped member 212. It is contemplated that the energizing element 212 may be formed as a beam that protrudes upward from a base, wherein the base can be attached to one of the plates 220, 230 (plate 220 in the exemplary example disclosed). On the opposing side (e.g. plate 230), the element 212 sits in a slot 222. It is contemplated that the element 212 may be formed of any appropriate material that functions with a mechanical memory as described previously. In a preferred embodiment, the element 212 is formed from a spring steel material.

In a fifth exemplary embodiment, shown in FIGS. 8A and 88, the energizing element 212 comprises a rod-shaped member. It is contemplated that this member 212 may be attached to one of the plates 220, 230 in a slot 222 or 232 and on the opposing side (e.g. plates 220 or 230), the element 212 sits in a slot 222. As with the first example, the element 212 may be formed of any appropriate material that functions with a mechanical memory as described previously.

In a sixth exemplary embodiment, as shown in FIGS. 9A and 98, the energizing element 212 comprises a matrix member element. It is contemplated that this matrix member element 212 may be adhered to one or both of the plates 220, 230. As with the first example, the element 212 may be formed of any appropriate material that functions with a mechanical memory as described previously. It is contemplated that the matrix may be formed as a sheet like material that includes features (not shown) such as pockets, bubbles, and/or with the addition of secondary material in a particular grain orientation (e.g. such as fibers) that help to provide the mechanical memory functionality.

Any numerical values recited herein or in the figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1-13. (canceled)

14. A clutch mechanism having an improved roller energizing element comprising:
an input plate of said clutch mechanism configured for rotation about an axis;
an opposing plate of said clutch mechanism configured for rotation about an axis;
at least one slot formed on the input plate and at least one slot formed on the opposing plate;
at least one roller member positioned between said at least one slot of said input plate and said at least one slot of said opposing plate, wherein said at least one roller member translates the rotational movement of the input plate to rotational and vertical movement of the opposing plate, wherein said at least one roller member is rotationally fixed to the opposing plate;
an undulating bearing surface formed on said at least one roller member; and
an undulating bearing surface formed on said at least one slot of said input plate, wherein said undulating bearing surface of said at least one roller member mates with said undulating bearing surface on said at least one slot formed on said input plate.

15. The clutch mechanism of claim 14 further comprising an undulating bearing surface formed on said at least one slot of said opposing plate, wherein said undulating bearing surface of said at least one roller member mates with said undulating bearing surface on said opposing plate.

16. The clutch mechanism of claim 15 wherein said undulating bearing surface on said opposing plate is sloped at an angle to translate the rotational motion of said input plate to vertical motion of said opposing plate.

17. The clutch mechanism of claim 14 wherein the undulating bearing surface of said input plate is sloped at an angle to translate the rotational motion of said input plate to vertical motion of said opposing plate.

18. A clutch mechanism having improved roller energizing element comprising:
an input plate of said clutch mechanism configured for rotation about an axis;
an opposing plate of said clutch mechanism;
a first slot formed on said input plate and a first slot formed on said opposing plate;
a second slot formed on said input plate and a second slot formed on said opposing plate;
a third slot formed on said input plate and a third slot formed on said opposing plate;
a first roller member rotatably positioned between said first slot of said input plate and said first slot of said opposing plate, wherein said first roller member translates the rotational movement of said input plate to the rotational and vertical movement of said opposing plate;
a second roller member rotatably positioned between said second slot of said input plate and said second slot of said opposing plate, wherein said roller member translates the rotational movement of said input plate to the rotational and vertical movement of said opposing plate;
a third roller member rotatably positioned between said third slot of said input plate and said third slot of said opposing plate, wherein said roller member translates the rotational movement of said input plate to the rotational and vertical movement of said opposing plate;
an undulating bearing surface formed on each one of said first roller member, said second roller member and said third roller member; and
an undulating bearing surface formed on each one of said first slot, said second slot and said third slot of said input plate, wherein said undulating bearing surface on a respective one of said first roller member, said second roller member and said third roller member mate with the respective said undulating bearing surface on said first slot, said second slot and said third slot of said input plate.

19. The clutch mechanism of claim 18 further comprising an undulating bearing surface formed on said first slot, said second slot and said third slot of said opposing plate, wherein said undulating bearing surface of said roller member mates with said undulating bearing surface the respective one or said first slot, said second slot and said third slot on said opposing plate.

20. The clutch mechanism of claim 19 wherein said first slot, said second slot and said third slot on said opposing plate are each sloped at an angle to translate the rotational motion of said input plate to vertical motion of said opposing plate.

21. The clutch mechanism of claim 18 wherein said first slot, said second slot and said third slot on said input plate are each sloped at an angle to translate the rotational motion of said input plate to vertical motion of said opposing plate.

22. A clutch mechanism having an improved roller energizing element comprising:
an input plate of said clutch mechanism configured for rotation about an axis;
an opposing plate of said clutch mechanism;
a first slot formed on said input plate;
a second slot formed on said input plate;
a third slot formed on said input plate;
a first roller member rotatably connected to said opposing plate and positioned between said first slot of said input plate and said opposing plate, wherein said first roller member translates the rotational movement of said input plate to the rotational and vertical movement of said opposing plate;
a second roller member rotatably connected to said opposing plate and positioned between said second slot of said input plate and said opposing plate, wherein said second roller member translates the rotational movement of said input plate to the rotational and vertical movement of said opposing plate;
a third roller member rotatably connected to said opposing plate and positioned between said third slot of said input plate and said opposing plate, wherein said third roller member translates the rotational movement of said input plate to the rotational and vertical movement of said opposing plate;
a bearing surface formed on each one of said first slot, said second slot and said third slot of said input plate, wherein said bearing surface is adapted to rotatably mate respectfully with a roller bearing surface formed on said first roller member, a roller bearing surface formed on said second roller member and a roller bearing surface formed on said third roller member.

23. The clutch mechanism of claim 22 further comprising a bearing surface formed on each one of said first slot, said second slot and said third slot of said input plate, wherein said bearing surface is adapted to rotatably mate respectfully with a roller bearing surface formed on said first roller member, a roller bearing surface formed on said second roller member and a roller bearing surface formed on said third roller member.

24. The clutch mechanism of claim 22 further comprising:
an undulating bearing surface formed on each one of said first roller member, said second roller member and said third roller member; and
an undulating bearing surface formed on each one of said first slot, said second slot and said third slot of said input plate, wherein said undulating bearing surface on a respective one of said first roller member, said second roller member and said third roller member mates with said undulating bearing surface on said first slot, said second slot and said third slot on said input plate.

25. The clutch mechanism of claim 22 wherein said first slot, said second slot and said third slot on said input plate are each sloped at an angle to translate the rotational motion of said input plate to vertical motion of said opposing plate.
